(19) United States
(12) Patent Application Publication
(10) Pub. No.: US 2020/0131052 A1
(43) Pub. Date: Apr. 30, 2020

(54) WATER STABLE GRANULES AND TABLETS

(71) Applicant: SOLENIS TECHNOLOGIES CAYMAN, L.P., George Town (KY)

(72) Inventors: Sharad MATHUR, Tega Cay, SC (US); Alex J. ATTLESEY, Waxhaw, NC (US); Xue LIU, Solon, OH (US)

(73) Assignee: SOLENIS TECHNOLOGIES CAYMAN, L.P., George Town (KY)

(21) Appl. No.: 16/626,892

(22) PCT Filed: Jun. 29, 2018
(86) PCT No.: PCT/US2018/040253

§ 371 Date: Dec. 27, 2019

Related U.S. Application Data
(60) Provisional application No. 62/526,756, filed on Jun. 29, 2017.

(51) Int. Cl. C02F 1/28; B30B 11/00

(52) U.S. Cl. CPC C02F 1/281; C02F 2101/20; B30B 11/006

(57) ABSTRACT

The present invention addresses the challenges of making water stable granules and/or water stable tablets without the use of a binder or heat. Disclosed herein are methods of forming water stable granules and/or water stable tablets, their composition and methods of their use.

### FIELD OF THE INVENTION

The present invention relates to water stable granules, water stable tablets, methods of their formation and methods of their use.

### BACKGROUND OF THE INVENTION

The use of ion exchangers, both organic and inorganic, such as, for instance, crystalline molecular sieve zeolites, in order to remove certain metals from aqueous solutions is notoriously old in the art and the patent and technical literature contains many examples of such techniques. Although molecular sieves generally are effective for the removal of certain contaminants, there remains a need in the art to form alternative, cost effective means for water and gas purification.

### SUMMARY

It is an object of certain embodiments of the disclosure to provide water stable granules and/or water stable tablets that could, among other applications, be suitable for use in water systems, including, but not limited to, remediation, treatment and/or purification and/or production of drinking water, with industrial waters, for pretreatment of reverse osmosis feed water and polishing steps, for tertiary treatments, for heavy metal contaminant (e.g., heavy metal ions) and radionuclide contaminants removal. In some embodiments, the water stable granules and/or water stable tablets may further comprise a lubricant.

It is an object of certain embodiments of the disclosure to provide a method for forming water stable granules through roller compaction and/or a method for forming water stable tablets through tablet pressing. In some embodiments, the method for forming water stable granules and/or water stable tablets does not include a heating step and/or does not include incorporating a binder. Thus, disclosed herein are water stable, binder-less, mineral granules and tablets produced via high pressure compaction.

It is an object of certain embodiments of the disclosure to provide a method for treating water contaminated with heavy metal cations, heavy metal anions, and mixtures thereof.

The term “oxides” means any chemical compound containing at least one oxygen atom and one other element in its chemical formula. The term “metal-oxides” means any chemical compound containing at least one metal atom and at least one oxygen atom. The metal atom may be, without limitations, selected from the group consisting of Ca, Mg, Al, Fe, Mn, Ti, Si, Cu, Ce, Zr, Y, Sn and mixtures thereof.

The term “hydroxides” means any chemical compound containing at least one oxygen and hydrogen atom held together by a covalent bond (OH—). The term “metal-hydroxides” means any chemical compound containing at least one metal atom and at least one oxygen and hydrogen atom held together be a covalent bond (OH—). The metal atom may be, without limitations, selected from the group consisting of Ca, Mg, Al, Fe, Mn, Ti, Si, Cu, Ce, Zr, Y, and mixtures thereof.

The term “water stable” means, in embodiments directed to tablets, tablets that retain about 70% or more, about 75% or more, about 80% or more, about 85% or more, about 90% or more, about 95% or more, about 96% or more, about 97% or more, about 98% or more, or about 99% or more of their strength in side crush test after being subjected to wet conditions. The side crush test is a measurement of the peak value of the forces for crushing a tablet between a fixed plate and a moving plate. In embodiments directed to granules and tablets, the term means that about 30% or less, about 25% or less, about 20% or less, about 15% or less, about 10% or less, about 5% or less, about 3% or less, or about 1% or less, or about 0.5% or less of the granules and/or tablets disintegrate in a disintegration test performed in static and/or agitated water. Disintegration may be measured in accordance with the following procedure: granules in a predetermined size range are pre-weighed and their mass is recorded as W1. Subsequently, the granules are inserted into static and/or agitated water for 24 hours. After 24 hours, the wetted granules are dried in an oven at 60° C. overnight. Thereafter, the dried granules are sieved based on the predetermined size range and weighed. The mass of the dried granules is recorded as W2. Finally, the disintegration percentage is calculated according to the following formula: (W1−W2)/W1*100%.

The term “dry strength” as used in the application with respect to the tablets refers to the crush strength of the tablets before being soaked in water.

The term “wet strength” as used in the application with respect to the tablets refers to the crush strength of the tablets after being soaked in water, and dried after the soaking.

The term “crush strength” refers to the capacity of a material to withhold compressive force. The crush strength of the tablets disclosed herein is measured by side crush test described in detail above.

The term “recycle” as used in the application may be understood as running the particles sample through the procedure at least a second time (i.e., a second pass) and in some embodiments through several subsequent passes. The second and/or subsequent passes could each independently be through the same machine (such as, the same roller compactor and/or the same tableting machine) or through different machines (for instance, different machines connected in series).

### BRIEF DESCRIPTION OF THE DRAWINGS

The above and other features of the present disclosure, their nature, and various advantages will become more apparent upon consideration of the following detailed description, taken in conjunction with the accompanying drawings, in which:

FIG. 1 depicts a chart summarizing the disintegration results in static and agitated water of water stable granules prepared in accordance with embodiments disclosed herein.

FIG. 2 depicts a chart summarizing the lead content in various effluent samples obtained after running lead contaminated deionized water through an adsorber bed comprising granules according to embodiments.

FIG. 3 depicts a chart summarizing the lead content in various effluent samples obtained after running lead contaminated deionized water through an adsorber bed comprising granules prepared according to U.S. Pat. No. 9,744,518.

### DETAILED DESCRIPTION

In some embodiments, the present disclosure is directed to a composition comprising water stable granules. In some embodiments, the present disclosure is directed to a composition comprising water stable tablets. The compositions disclosed herein may further comprise a lubricant and/or may be free from binders.

In some embodiments, the present disclosure is directed to a method comprising forming water stable granules through roller compaction. In some embodiments, the present disclosure is directed to a method for forming water stable tablets. The compositions disclosed herein may be formed through roller compaction and/or through press force as utilized in tableting for example. In some embodiments, the compositions disclosed herein may be prepared without being subjected to heat.

In some embodiments, the present disclosure is directed to methods of treating contaminated water with the compositions disclosed herein. For instance, a method for removing heavy metal contaminants from a water stream comprising contacting a water stream with roller compacted and ground water stable granules and/or with pressed water stable tablets.

Methods of Forming Water Stable Granules and/or Water Stable Tablets

In some embodiments, the present disclosure is directed to a method of forming water stable granules such that about 30% or less of the granules disintegrate in a disintegration test performed in static or in agitated water. The method may comprise feeding a powder into a roller compactor at a first compaction force to form a shape. The shape may depend on the rolls used in the roller compactor. For instance, the shape may be one or more of sheets, ribbons, briquettes, mixtures thereof, and any other suitable shape. The method may further comprise passing the shape through a grinder to form granules.

The method may further comprise passing the granules through zigzag sifter for dedusting. In a zigzag sifter, a series of plates may be installed in a vertical column with a certain angle. Granules may be added from the top of the column, pass through the plates and may be collected at the bottom. Air may blow from the bottom of the column at a controlled rate so the fines in the granules may get removed by the air. In other embodiments, the method may further comprise washing to remove fines formed during the granule formation process. The formed granules may be binder-less and water stable.

In some embodiments, the present disclosure is directed to a method comprising pressing a powder at a first force to form tablets. The formed tablets may be binder-less and water stable such that about 0% or less of the tablets disintegrate in a disintegration test performed in static or in agitated water.

The method for forming water stable granules and/or water stable tablets may further comprise blending the powder with a lubricant. The lubricant may be selected from the group consisting of a solid lubricant, a liquid lubricant, and mixtures thereof. Exemplary lubricants may include graphite, paraffin, hydrocarbon oil, polyols (e.g., ethylene oxide, propylene oxide, and copolymers thereof), silicone oil, perfluorated oil, fatty esters, fatty alcohols, magnesium stearate, and mixtures thereof.

In certain embodiments, the lubricant may be blended with the powder right before the powder is fed into a roller compactor to form water stable granules or right before the powder is pressed to form water stable tablets. In other embodiments, the lubricant may be blended with the metal-oxides, metal-hydroxides, metal-silizates, zeolites, or mixtures thereof used to form the powder, prior to powder formation. For instance, a liquid or solid lubricant may be blended with a metal-oxide or a metal-hydroxide compound(s) of interest, such as titanium silicate, to form a mixture. The mixture may be solid or liquid. The mixture may subsequently undergo further processing to form a powder that may be suitably fed into a roller compactor to form water stable granules or for pressing (e.g., tableting) to form water stable tablets. Further processing of the mixture may include, without limitations, spray drying a liquid mixture to form a spray dried powder that may be suitably fed into a roller compactor or a tableting machine.

Any lubricant may be used depending on the end use application of the water stable granules and/or tablets. For instance, if the water stable granules or tablets are used to treat drinking water to eliminate drinking water contaminants, the lubricant may have to be National Science Foundation (NSF) approved for drinking water applications. In embodiments utilizing roller compaction, where the lubricant is blended with the powder right before feeding into the roller compactor, solid lubricants may be utilized. For instance, solid lubricants may be selected from the group consisting of graphite, stearate salts such as those of calcium (Ca) and magnesium (Mg), polytetrafluorethylene (PTFE), and mixtures thereof. In some embodiments, liquid lubricants selected from the group consisting of base oils, synthetic oils, oils from biological sources such as vegetable oils, aqueous lubricants such as polyethylene glycol, and mixtures thereof may be used. In some embodiments, liquid lubricants may be blended with a metal-oxide or metal-hydroxide compound(s) of interest to form a mixture such that the mixture may undergo further processing prior to the roller compaction and/or tableting and/or pressing step. In other embodiments, the liquid lubricants may be blended with a metal-oxide or a metal-hydroxide compound(s) of interest immediately before being fed into the roller compaction and/or tableting and/or pressing step.

The method for forming water stable granules and/or water stable tablets may further comprise separating water stable granules and/or tablets of a specified size range from one or more of fines or oversized particles/tablets. The specified size range may include a lower size limit and an upper size limit for the water stable granules and/or tablets. “Fines” may include granules and/or tablets below the lower size limit in the specified size range. “Oversized particles/tablets” may include granules and/or tablets above the upper size limit.

For instance, the specified size range for water stable granules may range from about 50 μm, 100 μm, about 200 μm, about 300 μm, about 400 μm, about 500 μm, or about 600 μm to about 700 μm, about 800 μm, about 900 μm, about 1 mm, about 1.1 mm, about 1.2 mm, about 1.3 mm, about 1.4 mm, or about 1.5 mm. The specified size range for water stable tablets may range from about 0.5 mm, about 1 mm, about 1.1 mm, about 1.2 mm, about 1.3 mm, about 1.4 mm, about 1.5 mm, about 1.6 mm, about 1.7 mm, about 1.8 mm, about 1.9 mm, about 2 mm, about 2.5 mm, about 3 mm, about 3.5 mm, about 4 mm, or about 4.5 mm to about 5 mm, about 5.5 mm, about 6 mm, about 6.5 mm, about 7 mm, about 7.5 mm, about 8 mm, about 8.5 mm, about 9 mm, about 9.5 mm, about 1 cm, about 2 cm, or about 3 cm.

In some embodiments, the fines or oversized particles/tablets separated from the water stable granules and/or tablets of a specified size range are recycled. In some embodiments, the separated fines or oversized particles are disposed of. In other embodiments, the separated fines or oversized particles are utilized for an application different from the application for the water stable granules and/or tablets of the specified size range of interest.

In some embodiments where the fines or oversized particles/tablets are recycled, the recycling step may comprise feeding the fines or oversized particles back to the same roller compactor or into another roller compactor at a second compaction force to form a recycled shape. The recycling step may comprise passing the recycled shape through a grinder or a mill to form recycled granules that are water stable. The recycling step may comprise passing the recycled granules through a zigzag sifter for dedusting and/or through a washing step to reduce the amount of fines attached to the recycled granules. The recycled shape may be the same or different from the shape exiting the initial roller compaction step. For instance, the recycled shape may be one or more of sheets, ribbons, briquettes, mixtures thereof, and any other suitable shape.

In other embodiments, the recycling step may comprise passing the oversized particles/tablets through a grinder or a mill to reduce the size of the oversized particles to be within the specified size range of interest, thereby forming recycled granules that are water stable. This grinding step may be superseded with a step comprising passing the recycled granules through a zigzag sifter for dedusting and/or through a washing step to reduce the amount of fines attached to the recycled granules.

In other embodiments where the fines and/or oversized particles/tablets are recycled, the recycling step may comprise passing the fines and oversized particles/tablets through a grinder or a mill, feeding one or more of the ground particles back to the same roller compactor and/or tablet press or into another roller compactor and/or tablet press at a second force to form recycled tablets that are water stable.

The first compaction and/or press force exerted on the powder during the initial roller compaction and/or initial tableting (pressing) and the second compaction force and/or press force exerted on the fines and oversized particles when they are recycled through roller compactor and/or through tablet press may be the same or different. In some embodiments, the first compaction and/or press force and the second compaction and/or press force are the same. In other embodiments, the first compaction and/or press force is greater than the second compaction and/or press force. In yet other embodiments, the first compaction and/or press force is lower than the second compaction and/or press force. The first and/or the second compaction forces may range from about 20 kN, about 25 kN, about 30 kN, about 35 kN, about 40 kN, about 45 kN, about 50 kN, about 55 kN, about 60 kN, about 65 kN, about 70 kN, about 75 kN, or about 80 kN, to about 85 kN, about 90 kN, about 95 kN, about 100 kN, about 110 kN, about 120 kN, about 130 kN, about 140 kN, about 150 kN, about 160 kN, about 170 kN, about 180 kN, about 190 kN, or about 200 kN, about 210 kN, about 220 kN, about 230 kN, about 240 kN, about 250 kN, about 260 kN, about 270 kN, about 280 kN, about 290 kN, or about 300 kN. The first and/or the second press forces may range from about 3 kN, about 5 kN, about 10 kN, about 15 kN, about 20 kN, or about 25 kN, to about 30 kN, about 35 kN, about 40 kN, about 45 kN, about 50 kN, about 55 kN, about 60 kN, about 65 kN, about 70 kN, about 75 kN, about 80 kN, about 85 kN, about 90 kN, about 95 kN, or about 100 kN.

The roller compaction, tabletting, and milling may each occur over a duration of a few milliseconds to a few seconds (e.g., about 1 ms to about 10 seconds).

The water stable tablets and/or granules formed of a specified size range formed prior to recycling may have a similar size and appearance as the water stable tablets and/or granules formed after recycling.

In some embodiments, the granules and/or the tablets may be tested in a disintegration test in static and/or in agitated water. For instance, in some embodiments, about 30% or less, about 25% or less, about 20% or less, about 15% or less, about 10% or less, about 5% or less, about 3% or less, about 1% or less, or about 0.5% or less of the resulting granules and/or tablets disintegrate in a disintegration test performed in static water. In some embodiments, about 30% or less, about 25% or less, about 20% or less, about 15% or less, about 10% or less, about 5% or less, about 3% or less, about 1% or less, or about 0.5% or less of the resulting granules and/or tablets disintegrate in a disintegration test performed in agitated water. Exemplary disintegration tests are described in the Examples below.

In some embodiments, the water stable tablets may retain about 70% or more, about 75% or more, about 80% or more, about 85% or more, about 90% or more, or about 95% or more of their dry strength after being subject to wet conditions.

The water stable granules and/or tablets disclosed herein may be prepared without applying heat and/or without incorporating a binder.

Furthermore, the water stable granules and/or tablets prepared according to any of the methods disclosed herein may be suitable for treating water contaminated with one or more of heavy metal cations, heavy metal anions, or mixtures thereof.

Water Stable Granules and/or Water Stable Tablets

In some embodiments, the present disclosure is directed to a composition comprising roller compacted and ground, optionally dedusted, granules, wherein the granules are substantially free of binder.

In other embodiments, the present disclosure is directed to a composition comprising pressed tablets, wherein the tablets are substantially free of binder.

“Substantially free of binder” refers to granules having about 10% or less, about 9% or less, about 8% or less, about 7% or less, about 6% or less, about 5% or less, about 4% or less, about 3% or less, about 2% or less, about 1% or less, about 0.9% or less, about 0.8% or less, about 0.7% or less, about 0.6% or less, about 0.5% or less, about 0.4% or less, about 0.3% or less, about 0.2% or less, or about 0.1% or less of binder.

Granules and tablets prepared in accordance with the disclosure herein may be formed from a powder. The powder may be amorphous or crystalline. The powder used to form the water stable granules and/or tablets may comprise metal-oxides, metal-hydroxides, metal-silicates, zeolites, and mixtures thereof. In some embodiments, the powder may comprise titanium silicate (e.g., titanium silicate with a Ti:Si ratio ranging from 2:1 to 0.5 to 1). In some embodiments, titanium silicate may be selected since the adsorption of heavy metal ions on titanosilicate granules is not affected due to water hardness in the presence of competing ions (such as Ca and Mg ions) as disclosed in U.S. Pat. Nos. 5,053,139 and 9,744,518. The powder raw material may be produced for example by precipitation/washing and spray drying, drum drying, crushing and milling etc. The spray dried particles may be further pulverized. The powder may just be fines from a screening process of granules and can be optionally pulverized. The average particle size of the powder raw material may range from 10 μm to 100 μm.

In some embodiments, the granules and/or tablets may further comprise a lubricant. The lubricant may include but not be limited to, mineral lubricants, synthetic lubricants, vegetable lubricants, animal lubricants, fatty esters, and fatty alcohols. Mineral lubricants include, but are not limited to, fluid lubricants (oils) such as paraffinic oils, hydrocarbon oil, naphtenic oils, perfluorated oil, and aromatic oils; semi-fluid lubricants (greases); and solid lubricants such as graphite, molybdenum disulfide, boron nitride, tungsten disulfide, PTFE, and stearate salts (for instance stearate salts of Ca and Mg). Synthetic lubricants include, but are not limited to, polyalphaolefins (PAO), polyglycols (PAG), ester oils, and silicones. Vegetable lubricants may be based on soybean, corn, castor, canola, cotton seed, rape seed oils, etc. Animal lubricants may be produces from animal fat such as hard fats and soft fats.

The pressed tablets may have a wet strength that is about 70% or more, about 75% or more, about 80% or more, about 85% or more, about 90% or more, about 95% or more, about 96% or more, about 97% or more, about 98% or more, or about 99% or more of their dry strength.

In some embodiments, disintegration tests may be performed on the compositions disclosed herein. For instance, only about 30% or less, about 25% or less, about 20% or less, about 15% or less, about 10% or less, about 5% or less, about 3% or less, about 1% or less, or about 0.5% or less of the roller compacted and ground granules and/or the pressed tablets may disintegrate in disintegration tests performed in static and/or agitated water. Exemplary disintegration tests are described in the examples below.

In some embodiments, the present disclosure may be directed to a method of forming a composition, or to the composition itself, wherein the composition comprises roller compacted and ground granules, wherein the granules consist essentially of titanium silicate and are substantially free of binder, and wherein about 30% or less, about 20% or less, about 15% or less, about 10% or less, about 5% or less, about 3% or less, about 1% or less, or about 0.5% or less of the granules disintegrate in a disintegration test preformed in static and/or in agitated water. In certain embodiments, the granules may consist essentially of titanium silicate and lubricant and may still be substantially free of binder.

In certain embodiments, the present disclosure may be directed to a method of forming a composition, or to a composition itself, wherein the composition comprises pressed water stable tablets, wherein the tablets consist essentially of titanium silicate and are substantially free of binder, and wherein the tablets have a wet strength that is about 70% or more, about 75% or more, about 80% or more, about 85% or more, about 90% or more, about 95% or more, about 96% or more, about 97% or more, about 98% or more, or about 99% or more of their dry strength. In certain embodiments, the tablets may consist essentially of titanium silicate and lubricant and may still be substantially free of binder.

The following examples are set forth to assist in understanding the invention and should not, of course, be construed as specifically limiting the invention described and claimed herein. Such variations of the invention, including the substitution of all equivalents now known or later developed, which would be within the purview of those skilled in the art, and changes in formulation or minor changes in experimental design, are to be considered to fall within the scope of the invention incorporated herein.

### ILLUSTRATIVE EXAMPLES

### Example 1: Tableting and Crush Strength Test

Titanium silicate (TS) tablets were formed from TS powder (d₅₀ of 33 μm). Four TS tablets were placed in agitated water for 24 hours at an agitation speed of 50 rotations per minute (RPM). Additional four TS tablets were placed in static water for 24 hours. After 24 hours, the crush strength of fresh tablets (i.e. dry tablets that were not submerged in water) was compared to the crush strength of: (i) tablets submerged in agitated water for 24 hours and dried in an oven at 60° C. overnight, and (ii) of tablets submerged in static water for 24 hours dried in an oven at 60° C. overnight. The results are summarized in Table 1 below.

TABLE 1
Crush Strength Comparison

| Samples | Crush Strength (Lb) |
|---|---|
| Fresh tablets | 19.6 |
| (i) In static water | 14.3 |
| (ii) In agitated water | 14.0 |

As illustrated in Table 1, wet TS tablets retain at least 70% of their dry crush strength, regardless of whether the tablets are submerged in static or in agitated water.

### Example 2: Forming Granules Through Roller Compaction

Two batches of Titanium Silicate (TS) granules were formed using the procedure detailed below.

1. 5000 g of titanium silicate powder was blended with 100 g of graphite.
2. Roller compactor setup—20 gauge for scraper clearance, pressure transducer 4-5 kN, 1.25 mm screen on granulator, no vacuum.
3. Poured blended material into the feed hopper.
4. Turned on the vacuum and started taking samples.
5. For the first batch, samples were taken for runs with a compression force of 35 kN, 45 kN, 55 kN, 65 kN, 75 kN, and 85 kN. The second batch was prepared using a compression force of 85 kN throughout.
6. Fines and oversized particles generated in the first batch were recycled for a second pass through the roller compactor at a second compression force of 85 kN.
7. Fines and oversized particles generated in the second batch were recycled for a second pass through the roller compactor at a second compression force of 85 kN.
8. Granules within a specified size range were separated from fines and from oversized particles.

A sample of the first batch ribbons exiting the roller compactor after a roller compactor run with a compression force of 45 kN was collected. A sample of the first batch ribbons exiting the roller compactor after a roller compactor run with a compression force of 85 kN was also collected. Roller compaction runs with a higher compression force result in stronger ribbons and less fines.

A sample of the first batch ribbons exiting the roller compactor after a single pass through the roller compactor was collected. A sample of the first batch recycled ribbons exiting the roller compactor after a second pass through the roller compactor was also collected. Recycling the fines and oversized particles and passing them through the roller compactor a second time results in stronger ribbons and less fines.

A plurality of samples were retrieved from the first batch after recycling. Each of the samples corresponds to particles within a specified size range. The first sample contains particles that are about 300 μm or lower in size. The second sample contains particles that are about 300 μm to about 500 μm in size. The third sample contains particles that are about 500 μm to about 840 μm in size. The fourth sample contains particles that are about 840 μm to about 1.18 mm in size. The fifth sample contains particles that are about 1.18 mm and higher in size. Table 2 below describes the percentage that each particle size range constitutes.

TABLE 2
Particle Size Distribution - Samples 1-5

| | Percentage |
|---|---|
| Samples from first batch after recycling | (Total 100%) |
| First sample - about 300 μm or less | 38.1% |
| Second Sample - about 300 μm to about 500 μm | 9.2% |
| Third Sample - about 500 μm to about 840 μm | 19.3% |
| Fourth Sample - about 840 μm to about 1.18 mm | 31.6% |
| Fifth Sample - about 1.18 mm or more | 1.8% |

A plurality of samples were retrieved from the second batch before recycling. Each of the samples corresponds to particles within a specified size range. The first sample contains particles that are about 300 μm or lower in size. The second sample contains particles that are about 300 μm to about 500 μm in size. The third sample contains particles that are about 500 μm to about 840 μm in size. The fourth sample contains particles that are about 840 μm to about 1.18 mm in size. The fifth sample contains particles that are about 1.18 mm and higher in size. Table 3 below describes the percentage that each particle size range constitutes. Table 3 further compares the percentage that each particle size range constitutes before and after recycling the second batch. Table 3 confirms that recycling and passing the particles through the roller compactor a second time reduces the amount of fines.

TABLE 3
Particle Size Distribution

| | Percentage | Percentage |
|---|---|---|
| | (Total 100%) | (Total 100%) |
| | Before | After |
| | Recycling - 1^{st} | Recycling - 2^{nd} |
| Samples from | Roller | Roller |
| second batch | Compactor Pass | Compactor Pass |
| First Sample - about | 53.1% | 32.1% |
| 300 μm or less | | |
| Second Sample - about | 5.9% | 9.1% |
| 300 μm to about | | |
| 500 μm | | |
| Third Sample - about | 14.8% | 20.8% |
| 500 μm to about | | |
| 840 μm | | |
| Fourth Sample - about | 24.0% | 33.5% |
| 840 μm to about | | |
| 1.18 mm | | |
| Fifth Sample - about | 2.2% | 4.6% |
| 1.18 mm or more | | |

### Example 3: Water Stable Granules—Disintegration Test

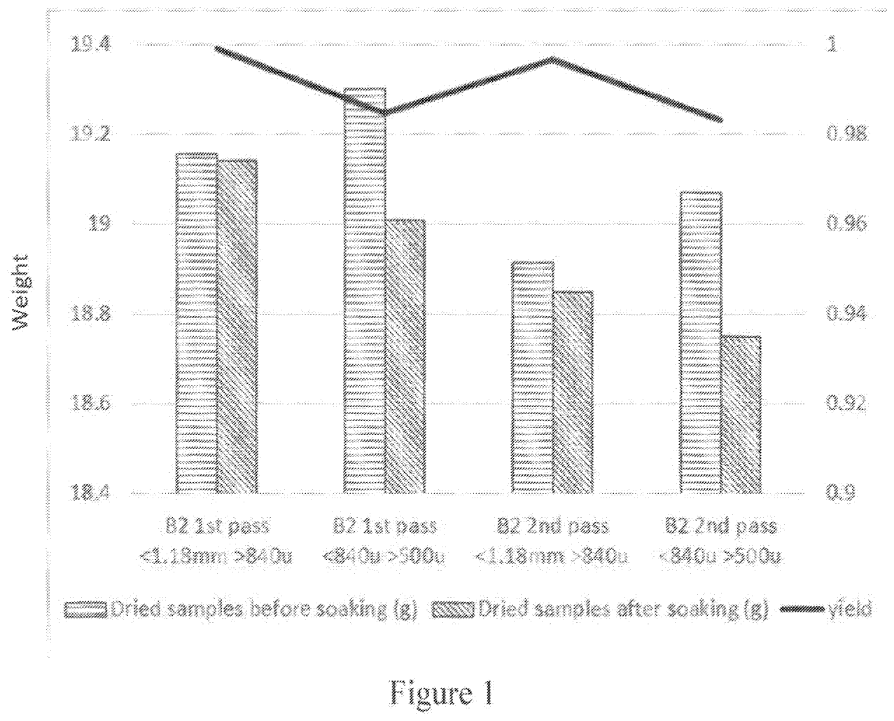

Water stable granules formed in Example 2, having a size range from about 500 μm to about 840 μm and 840 μm to 1.18 mm, were placed in agitated water for 24 hours at an agitation speed of 50 rotations per minute (RPM) and in static water for 24 hours. FIG. 1 illustrates a chart comparing the weight of the dry granules before soaking to the weight of the dry granules after soaking. The weight percent difference is summarized in Table 4 below.

TABLE 4
Water Stable Granules - Disintegration Test Summary in Static Water - FIG. 1

| | | Dried samples | Dried samples | Percent |
|---|---|---|---|---|
| | Dried | after soaking | after soaking | granules |
| | samples | within | below min limit | within |
| | before | specified size | in specified | specified |
| Sample | soaking (g) | range (g) | size range | size range |
| B1 2nd pass <1.18 | 19.65 | 19.28 | 0.24 | 98.11% |
| mm >840 μm | | | | |
| B1 2nd pass <840 | 19.46 | 18.59 | 0.56 | 95.52% |
| μm >500 μm | | | | |
| B2 1st pass <1.18 | 19.16 | 18.82 | 0.32 | 98.25% |
| mm >840 μm | | | | |
| B2 1st pass <840 | 19.30 | 18.5 | 0.51 | 95.84% |
| μm >500 μm | | | | |
| B2 2nd pass <1.18 | 18.91 | 18.54 | 0.31 | 98.03% |
| mm >840 μm | | | | |
| B2 2nd pass <840 | 19.07 | 18.28 | 0.47 | 95.86% |
| μm >500 μm | | | | |

Table 5 below compares the weight of the dry granules before soaking to the weight of the dry granules after soaking in agitated water for 24 hours. Table 5 also summarizes the weight percent difference for the granules before and after soaking in agitated water.

TABLE 5
Water Stable Granules - Disintegration Test Summary in Agitated Water

| | | Dried samples | Dried samples | Percent |
|---|---|---|---|---|
| | Dried | after soaking | after soaking | granules |
| | samples | within | below min limit | within |
| | before | specified size | in specified | specified |
| Sample | soaking (g) | range (g) | size range | size range |
| B2 2nd pass <1.18 | 19.02 | 18.13 | 0.45 | 95.34% |
| mm >840 μm | | | | |
| B2 2nd pass <840 | 18.64 | 17.38 | 0.61 | 93.24% |
| μm >500 μm | | | | |

As illustrated in Tables 4 and 5, granules prepared in accordance with embodiments disclosed herein maintain their integrity even after soaking in static and/or agitated water for 24 hours. The data showed in Table 4 and 5 is based on the process without a dedusting step (using a zigzag sifter).

### Example 4: Water Stable Granules—Dedusting Test

It was further noted that the fines identified in the dried samples after soaking (i.e. dried samples after soaking that are below the minimum size limit in the specified size range) are not the result of disintegration of the water stable granules. It is believed that the fines adhere to the larger water stable granules and get released when the larger water stable granules are soaked in water. It is believed that the fines may be removed with a preliminary soaking of the larger water stable granules such that in subsequent exposure to water no more fines will be released. It is believed that the fines may be removed with a dedusting step using a zigzag sifter and/or a washing step. Indeed, soaking the samples in water before dedusting resulted in cloudy water. In contrast, soaking the samples after a dedusting step that included removing the fines attached to the water stable granules in a zigzag sifter resulted in clearer water. Thus, the disintegration level may be reduced through removal of fines (e.g., by dedusting). In some embodiments, a lower precentage of dedusted granules or dedusted tablets disintegrate than the precentage of granules or tablets that disintegrate without dedusting as compared in a disintegration test performed in statis or in agitated water.

### Example 5: Performance of Inventive Granules Versus Granules of U.S. Pat. No. 9,744,518

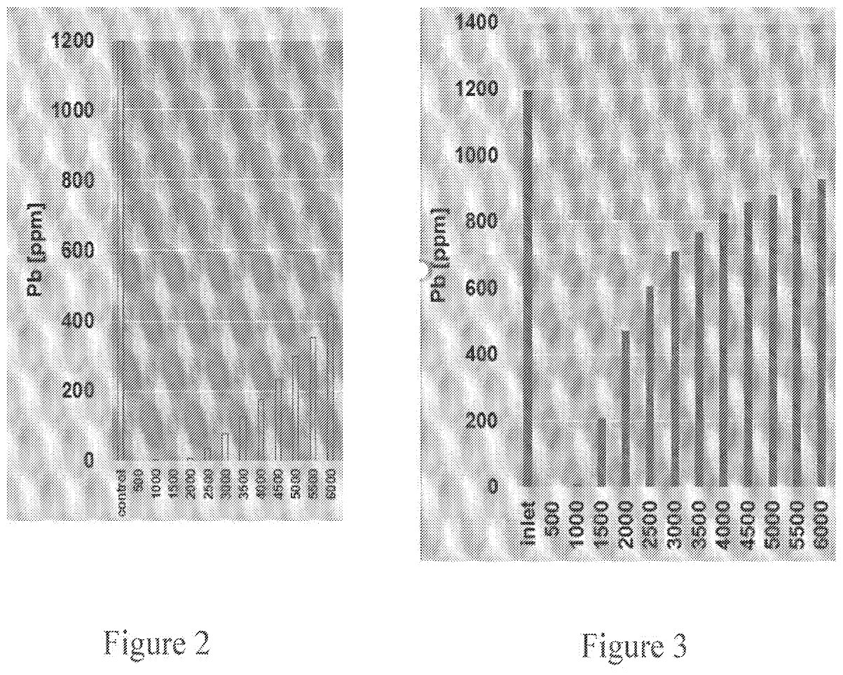

50 g of granules from about 50 kg batch prepared through invention, i.e. using spray dried powder as the feed and processing through the roller compaction and grinding process with 2% graphite lubricant was taken and washed with water and placed in a dynamic adsorption testing column. The column dimensions being 1.45 cm in diameter and the absorber bed being about 8 cm in height. Deionized water containing 1200 ppm lead (lead nitrate dissolution) was passed through the column at a flow rate of 30 ml/min and effluent samples were collected every 500 ml. The samples were tested for residual lead concentration. A total volume of 6000 ml was run through the column. The data summarized in Table 6 below and illustrated in FIG. 2 shows that the breakthrough (i.e. presence of lead in the effluent water) was first detected after 2000 ml of lead contaminated water has passed through the adsorber bed (i.e., through the inventive granules). Further, 200 ppm lead appeared in the effluent after about 4500 ml of contaminated water has passed through the adsorber bed.

The performance of the inventive granules was compared to the performance of granules prepared according to the teachings of U.S. Pat. No. 9,744,518 (hereinafter the '518 patent). 50 g of granules prepared according to the '518 patent were used to form an adsorber bed. The performance of the '518 patent granules was tested in as described above for the inventive granules. The results are summarized in Table 6 below and illustrated in FIG. 3. The data shows that the breakthrough was first detected after 1000 ml of lead contaminated water has passed through the adsorber bed (i.e., after passing through the absorber bed half the volume than that seen with the inventive granules). Furthermore, 200 ppm lead appeared in the effluent after about 1500 ml of contaminated water has passed through the adsorber bed (i.e., after passing through the absorber bed one third the volume than that seen with the inventive granules).

TABLE 6
Performance of Inventive Granules versus
Granules of U.S. Pat. No. 9,744,518

| | Inventive Granules | Granules of US ′518 |
|---|---|---|
| Sample | Pb (ppm) | Pb (ppm) |
| Control | 1200 | 1200 |

| | | | |
|---|---|---|---|
| 500 | mL | 0 | 0 |
| 1000 | mL | 0 | ~5 |
| 1500 | mL | 0 | ~200 |
| 2000 | mL | ~10 | ~475 |
| 2500 | mL | ~50 | ~600 |
| 3000 | mL | ~100 | ~700 |
| 3500 | mL | ~130 | ~785 |
| 4000 | mL | ~180 | ~815 |
| 4500 | mL | ~220 | ~850 |
| 5000 | mL | ~300 | ~875 |
| 5500 | mL | ~375 | ~900 |
| 6000 | mL | ~410 | ~925 |

Thus, even though both products, the inventive granules and the granules of the '518 patent, may have had the same chemical composition and form (amorphous titanium silicate), the inventive granules demonstrated a superior performance. The superior performance of the inventive granules may be attributed, without limitations, to a different morphology of the granules that may have been achieved due to a different manufacturing process.

### Example 6: Turbidity Testing of Inventive Granules

Turbidity was measured on granules by taking 10 g granules in 100 ml DI water and stirring with a stir bar at low rpm setting (also referred to as gentle swirling) for 5 seconds that produced cloudiness in water. The turbidity was 950 NTU and the suspended particles weighed 0.17 g corresponding to disintegration of 1.7%. After the water was decanted it was replaced with fresh DI water and 5 seconds stirring done. This process was repeated and the Table 7 below shows that the cloudiness or the NTU value decreased consistent with the decrease in the amount of suspended solids.

TABLE 7
Turbidity Results

| Weight of Material Dried | Turbidity (NTU) |
|---|---|
| 0.1691 | 950 |
| 0.0824 | 950 |
| 0.0401 | 365 |
| 0.0354 | 243 |
| 0.0244 | 367 |
| 0.0157 | 132 |
| 0.0161 | 247 |
| 0.0186 | 170 |
| 0.022 | 97.3 |
| 0.0388 | 116 |
| 0.015 | 102 |
| 0.0218 | 97.7 |
| 0.0149 | 84.9 |
| 0.0108 | 48.3 |
| 0.0078 | 39.2 |
| 0.0102 | 31.1 |
| 0.0218 | 51.4 |
| 0.0165 | 46.2 |
| 0.0064 | 24 |
| 0.0084 | 18.4 |

The invention disclosed herein may be described, without limitations, in the following numbered paragraphs:

1. A method comprising:

feeding a powder into a roller compactor at a first compaction force to form a shape; and passing the shape through a grinder to form granules;
wherein the formed granules are water stable such that about 30% or less of the granules disintegrate in a disintegration test performed in static or in agitated water.

2. A method comprising:

pressing a powder at a first force to form tablets, wherein the formed tablets are water stable such that about 30% or less of the tablets disintegrate in a disintegration test performed in static or in agitated water.

3. A method comprising:

feeding a powder into a roller compactor at a first compaction force to form a shape; and passing the shape through a grinder to form granules;
wherein the formed granules comprise titanium silicate and are water stable,

4. The method of any one of 1-3, further comprising blending the powder with a lubricant selected from the group consisting of solid lubricants, liquid lubricants, and mixtures thereof.

5. The method of 4, wherein the lubricant comprises one or more of graphite, magnesium stearate, paraffin, hydrocarbon oil, polyols, silicone oil, perfluorated oil, fatty esters, fatty alcohols.

6. The method of any one of 1 or 2, wherein the powder comprises metal-oxides, metal-hydroxides, metal-silicates, zeolites, and mixtures thereof.

7. The method of any one of 1 or 2, wherein the powder comprises titanium silicate.

8. The method of any one of 1 or 3, further comprising separating water stable granules of a specified size range from one or more of fines or oversized particles.

9. The method of any one of 1 or 3, wherein no more than 50 wt % of the granules range in size from about 50 μm to about 500 μm.

10. The method of 2, further comprising separating water stable tablets of a specified size range from one or more of fines and oversized tablets.

11. The method of 2, wherein the water stable tablets have a size ranging from about 0.5 mm to about 3 cm.

12. The method of 8, further comprising recycling one or more of the fines or oversized particles.

13. The method of 10, further comprising recycling one or more of the fines or oversized tablets.

14. The method of 12, wherein the recycling step comprises:

feeding one or more of the fines or oversized particles into a roller compactor at a second compaction force to form a recycled shape;
passing the recycled shape through a grinder to form recycled granules;
wherein the recycled granules are water stable.

15. The method of 13, wherein the recycling step comprises:

grinding the one or more of the fines or oversized tablets in a grinder or a mill to form ground particles, and
pressing the ground particles at a second force to form recycled tablets, wherein the formed recycled tablets are water stable.

16. The method of 14, wherein the water stable granules formed prior to recycling and separated from the one or more fines or oversized particles are of similar size as the recycled water stable granules formed after recycling.

17. The method of 15, wherein the water stable tablets formed prior to recycling and separated from the one or more fines or oversized tablets are of similar size as the recycled tablets formed after recycling.

18. The method of any one of 1 or 3, further comprising dedusting the formed granules.

19. The method of 14, further comprising dedusting the formed recycled granules.

20. The method of any one of 1 or 3, wherein about 20% or less, about 10% or less, about 5% or less, about 3% or less, or about 1% or less of the water stable granules disintegrate in a disintegration test preformed in agitated or static water.

21. The method of 2, wherein about 20% or less, about 10% or less, about 5% or less, about 3% or less, or about 1% or less of the water stable tablets disintegrate in a disintegration test preformed in agitated or static water.

22. The method of any one of 1 or 3, wherein the first compaction force ranges from about 35 kN to about 300 kN or from about 65 kN to about 300 kN.

23. The method of 14, wherein the second compaction force ranges from about 35 kN to about 300 kN or from about 65 kN to about 300 kN.

24. The method of 14, wherein the first compaction force and the second compaction force are the same.

25. The method of 14, wherein the first compaction force is greater than the second compaction force.

26. The method of 14, wherein the first compaction force is lower than the second compaction force.

27. The method of 2, wherein the first force ranges from about 3 kN to about 100 kN.

28. The method of 15, wherein the second force ranged from about 3 kN to about 100 kN.

29. The method of 15, wherein the first force and the second force are the same.

30. The method of 15, wherein the first force is greater than the second force.

31. The method of 15, wherein the first force is lower than the second force.

32. The method of any one of 1 or 3, wherein the water stable granules are suitable for treating water contaminated with one or more of heavy metal cations, heavy metal anions, or a mixture thereof.

33. The method of any one of 1 or 3, wherein the water stable granules are formed without applying heat, incorporating a binder, or a combination thereof.

34. The method of 2, wherein the water stable tablets are formed without applying heat, incorporating a binder, or a combination thereof.

35. The method of 2, wherein the water stable tablets retain about 70% or more, about 80% or more, about 85% or more, about 90% or more, or about 95% or more of their dry strength after being subjected to wet conditions.

36. A method for removing heavy metal contaminants from a water stream comprising:

contacting the water stream with roller compacted and ground water stable granules of 1 or 3.

37. A method comprising:

forming water stable titanium silicate granules through roller compaction.

38. A composition comprising: roller compacted and ground granules, wherein the granules are substantially free of binder, and wherein about 30% or less of the granules disintegrate in a disintegration test preformed in static or agitated water.

39. A composition comprising: roller compacted and ground titanium silicate granules, wherein the granules are substantially free of binder, and wherein the granules are water stable.

40. The composition of any one of 38-39, wherein about 20% or less, about 15% or less, about 10% or less, about 5% or less, about 3% or less, or about 1% or less of the granules disintegrate in a disintegration test preformed in static or agitated water.

41. The composition of any one of 38 to 40, further comprising a lubricant selected from the group consisting of solid lubricants, liquid lubricants, and mixtures thereof.

42. The composition of 41, wherein the lubricant comprises one or more of graphite, magnesium stearate, paraffin, hydrocarbon oil, polyols, silicone oil, perfluorated oil, fatty esters, fatty alcohols.

43. The composition of 38, wherein the granules comprise titanium silicate.

44. A composition comprising: pressed tablets, wherein the tablets are water stable, wherein about 30% or less of the tablets disintegrate in a disintegration test preformed in static or agitated water, and wherein the tablets have a wet strength that is about 70% or more of their dry strength.

45. The composition of 44, wherein the tablets have a wet strength that is about 75% or more, about 80% or more, about 85% or more, or about 90% or more of their dry strength.

46. The composition of any one of 44 to 45, further comprising a lubricant selected from the group consisting of solid lubricants, liquid lubricants, and mixtures thereof.

47. The composition of 46, wherein the lubricant comprises one or more of graphite, magnesium stearate, paraffin, hydrocarbon oil, polyols, silicone oil, perfluorated oil, fatty esters, fatty alcohols.

48. The composition of any one of 44-47, wherein the tablets comprise titanium silicate.

49. The composition of any one of 44-48, wherein about 20% or less, about 10% or less, about 5% or less, about 3% or less, or about 1% or less of the tablets disintegrate in a disintegration test preformed in static or agitated water.

50. A composition comprising roller compacted and ground granules,

wherein the granules consist essentially of titanium silicate and are substantially free of binder, and
wherein about 20% or less of the granules disintegrate in a disintegration test preformed in static or agitated water.

51. A composition comprising roller compacted and ground granules,

wherein the granules consist essentially of titanium silicate, lubricant, and are substantially free of binder, and
wherein about 20% or less of the granules disintegrate in a disintegration test preformed in static or agitated water.

52. A composition comprising pressed tablets,

wherein the tablets consist essentially of titanium silicate and are substantially free of binder, and
wherein the tablets have a wet strength that is about 70% or more of their dry strength.

53. A composition comprising pressed tablets,

wherein the tablets consist essentially of titanium silicate, lubricant, and are substantially free of binder, and
wherein the tablets have a wet strength that is about 70% or more of their dry strength.

54. A method comprising:

forming water stable granules through roller compaction,
wherein the water stable granules consist essentially of titanium silicate and are substantially free of binder, and
wherein about 20% or less of the granules disintegrate in a disintegration test preformed in static or agitated water.

55. A method comprising:

forming water stable granules through roller compaction,
wherein the granules consist essentially of titanium silicate, lubricant, and are substantially free of binder, and
wherein about 20% or less of the granules disintegrate in a disintegration test preformed in static or agitated water.

56. A method comprising:

forming pressed water stable tablets,
wherein the water stable tablets consist essentially of titanium silicate and are substantially free of binder, and
wherein the tablets have a wet strength that is about 70% or more of their dry strength.

57. A method comprising:

forming water stable pressed tablets,
wherein the tablets consist essentially of titanium silicate, lubricant, and are substantially free of binder, and
wherein the tablets have a wet strength that is about 70% or more of their dry strength.

For simplicity of explanation, the embodiments of the methods of this disclosure are depicted and described as a series of acts. However, acts in accordance with this disclosure can occur in various orders and/or concurrently, and with other acts not presented and described herein. Furthermore, not all illustrated acts may be required to implement the methods in accordance with the disclosed subject matter. In addition, those skilled in the art will understand and appreciate that the methods could alternatively be represented as a series of interrelated states via a state diagram or events.

In the foregoing description, numerous specific details are set forth, such as specific materials, dimensions, processes parameters, etc., to provide a thorough understanding of the present invention. The particular features, structures, materials, or characteristics may be combined in any suitable manner in one or more embodiments. The words “example” or “exemplary” are used herein to mean serving as an example, instance, or illustration. Any aspect or design described herein as “example” or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Reference throughout this specification to “an embodiment”, “certain embodiments”, or “one embodiment” means that a particular feature, structure, or characteristic described in connection with the embodiment is included in at least one embodiment. Thus, the appearances of the phrase “an embodiment”, “certain embodiments”, or “one embodiment” in various places throughout this specification are not necessarily all referring to the same embodiment.

The term “about”, when referring to a physical quantity, is to be understood to include measurement errors within, and inclusive of 2%. For example, “about 100° C.” should be understood to mean “100±1° C.”.

The present invention has been described with reference to specific exemplary embodiments thereof. The specification and drawings are, accordingly, to be regarded in an illustrative rather than a restrictive sense. Various modifications of the invention in addition to those shown and described herein will become apparent to those skilled in the art and are intended to fall within the scope of the appended claims.

1. A method comprising:
feeding a powder into a roller compactor at a first compaction force to form a shape; and
passing the shape through a grinder to form granules;
wherein the formed granules are water stable such that about 30% or less of the granules disintegrate in a disintegration test performed in static or in agitated water.

2. (canceled)

3. A method comprising:
feeding a powder into a roller compactor at a first compaction force to form a shape; and
passing the shape through a grinder to form granules;
wherein the formed granules comprise titanium silicate and are water stable,

4. The method of claim 1, further comprising blending the powder with a lubricant selected from the group of solid lubricants, liquid lubricants, and mixtures thereof.

5. The method of claim 4, wherein the lubricant comprises one or more of graphite, magnesium stearate, paraffin, hydrocarbon oil, polyols, silicone oil, perfluorated oil, fatty esters, fatty alcohols.

6. The method of claim 1, wherein the powder comprises inorganic materials selected from the group of metal-oxides, metal hydroxides, zeolites, metal silicates, and mixtures thereof.

7. The method of claim 1, wherein the powder comprises titanium silicate.

8. The method of claim 1, wherein no more than 50 wt % of the granules range in size from about 50 μm to about 500 μm.

9. (canceled)

10. The method of claim 1, wherein about 20% or less of the water stable granules disintegrate in a disintegration test preformed in agitated or static water.

11. The method of claim 1, wherein the first compaction force ranges from about 35 kN to about 300 kN.

12. (canceled)

13. The method of any one of claims 1-3, wherein the water stable granules or water stable tablets are formed without applying heat, incorporating a binder, or a combination thereof.

14. (canceled)

15. A method for removing heavy metal contaminants, heavy metal anions, or a mixture thereof from a water stream comprising:
contacting the water stream with roller compacted and ground water stable granules of claim 1.

16. (canceled)

17. (canceled)

18. The method of claim 1, further comprising de-dusting the granules, wherein a lower percentage of de-dusted granules or de-dusted tablets disintegrate than the percentage of granules or tablets that disintegrate without de-dusting as compared in a disintegration test performed in static or in agitated water.

19. The method of claim 1, further comprising separating water stable granules of a specified size range from one or more of fines or oversized particles; and recycling the one or more of the fines or oversized particles.

20. The method of claim 1, wherein about 1% or less of the water stable granules disintegrate in a disintegration test preformed in agitated or static water.
